(19) United States
(12) Patent Application Publication
(10) Pub. No.: US 2009/0074826 A1
(43) Pub. Date: Mar. 19, 2009

(54) EXTRUDED COMPONENT WITH ANTIMICROBIAL COMPONENT

(75) Inventor: Vinesh Naik, Plains, PA (US)

Correspondence Address: AKERMAN SENTERFITT, P.O. BOX 3188, WEST PALM BEACH, FL, 33402-3188, US

(73) Assignee: Noble Fiber Technologies, LLC, Scranton, PA (US)

(21) Appl. No.: 12/196,940

(22) Filed: Aug. 22, 2008

Related U.S. Application Data
(60) Provisional application No. 60/957,293, filed on Aug. 22, 2007.
(60) Provisional application No. 61/035,612, filed on Mar. 11, 2008.

(51) Int. Cl. A01N 25/34

(52) U.S. Cl. 424/404

(57) ABSTRACT

An extruded component formed from an extruded material having antimicrobial components is disclosed. The extruded material may be formed from polymers and formed into a generally elongated shape. The antibacterial components may extend from an outer surface of the extruded material radially outward. A color dye coating may be placed on the outer surface of the extruded material. The antibacterial component may be sized such that the color dye coating may be applied to the outer surface of the extruded material without compromising the effectiveness of the antibacterial component.

### CROSS-REFERENCE TO RELATED APPLICATIONS

This application claims the benefit of U.S. Provisional Application No. 60/957,293 filed, Aug. 22, 2007 and claims the benefit of U.S. Provisional Application No. 61/035,612, filed Mar. 11, 2008, both of which are incorporated by reference in their entirety.

### FIELD OF THE INVENTION

This invention is directed generally to antimicrobial materials, and more particularly to antimicrobial materials formed as filaments.

### BACKGROUND

Many filaments are formed from extrusion for a variety of uses. The filaments are often coated with a dye to create a filament of a chosen color. The filaments may be combined with each other to form a fabric or other useful object. Filaments and fabrics have been coated with antimicrobial materials to create an item useful in regulating microbes. The antimicrobial materials are typically coated on the outer surface of the filaments.

### SUMMARY OF THE INVENTION

This invention is directed to an extruded component including one or more antimicrobial components incorporated within the extruded component during the manufacturing process. The antimicrobial components may be sized relative to a cross-sectional dimension of the extruded component such that the antimicrobial components extend radially outward from an outer surface of the extruded material forming the extruded component. A color dye coating may be placed on the outer surface of the extruded material. The antibacterial component may be sized such that the color dye coating may be applied to the outer surface of the extruded material without compromising the effectiveness of the antibacterial component.

The extruded component may be formed from an extruded material forming a general elongated shape and may include at least one antibacterial component in the extruded materials that extends radially outward from an outer surface of the extruded material. The extruded material is formed from polymers and may be formed from a configuration selected from the group consisting of a single component, a bicomponent and a tricomponent. The extruded material may be formed into a shape selected from the group consisting of a filament, staple, microfiber, and fabrics.

The at least one antibacterial component may be formed from at least one material selected from the group consisting of salts, pure metals, and alloys. The pure metals may be, but is not limited to, sliver, tin, copper, zinc, cobalt and gold. The at least one antibacterial component may have a cross-sectional dimension of between 200 nm and 100 microns. the extruded material may have a cross-sectional dimension of between about 1.5 microns and 1,000 microns.

The extruded component may also include a color dye coating on the outer surface of the extruded material. At least a portion of the at least one antibacterial component may protrude through the color dye coating. The extruded component may be coated with a dye coating to color the extruded component as desired.

An advantage of this invention is that the size of the antimicrobial components, which may be metal ions, causes the antimicrobial components to extend radially outward from the surface of the extruded component. In such position, the extruded component may be dyed with a dye coating without compromising the effectiveness of the metal particles. The size of the antimicrobial components enables the metal particles to protrude radially outwardly from a surface of the extruded component a sufficient distance such that when dyed, the metal particles are not completely coated with the dye, thereby not negatively impacting the efficiency of the metal particles.

Another advantage of this invention is that the size of the antimicrobial components enables the antimicrobial components to be seen with a microscope protruding radially outward from the extruded component, which is advantageous for quality control, marketing, and customer satisfaction purposes.

Yet another advantage of this invention is that the antimicrobial components may be evenly distributed throughout the sheath, thereby improving the effectiveness of the antimicrobial components.

Another advantage of this invention is that because the silver is exposed radially outward from the nylon sheath layer, the extruded component may be metallized.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of an extruded component.

FIG. 2 is a cross-sectional view of the extruded component taken along section line 2-2 in FIG. 1.

FIG. 3 is a perspective view of an alternative extruded component.

FIG. 4 is a cross-sectional view of the alternative extruded component taken along section line 4-4 in FIG. 3.

FIG. 5 is a perspective view of a coating of the extruded component.

### DETAILED DESCRIPTION OF THE INVENTION

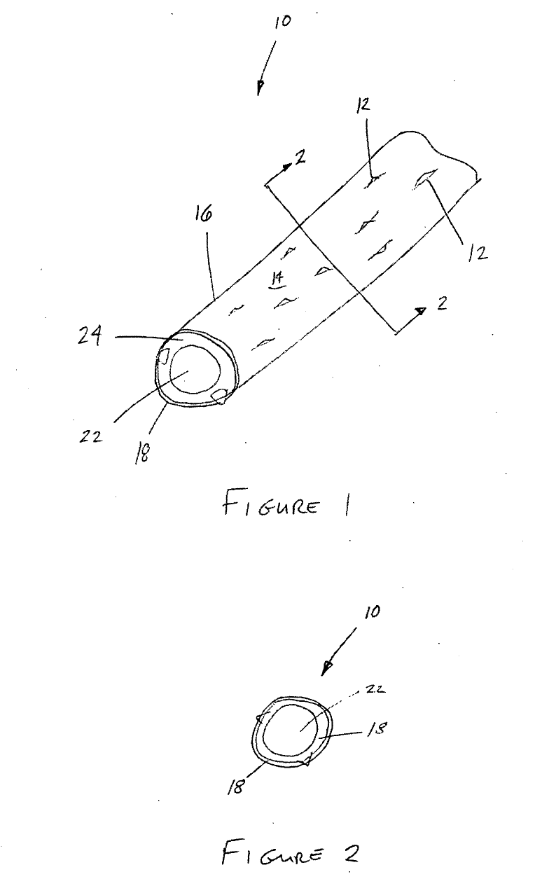

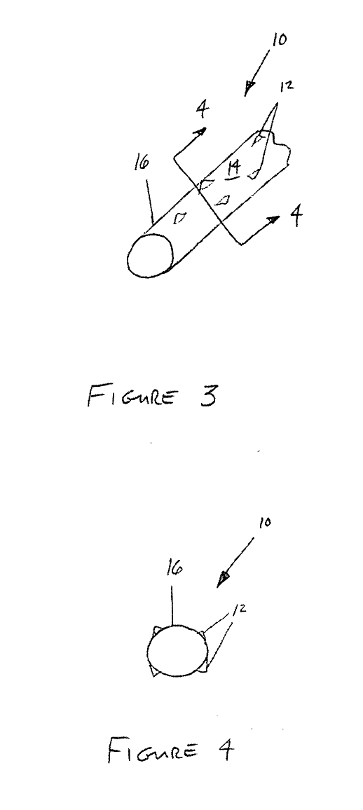

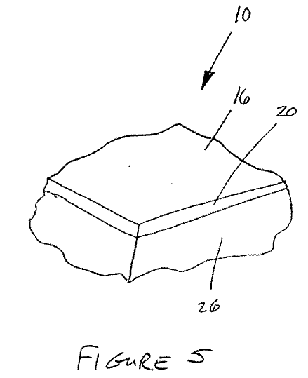

As shown in FIGS. 1-5, this invention is directed to an extruded component 10 including one or more antimicrobial components 12 incorporated within the extruded component 10 during the manufacturing process. The antimicrobial components 12 may be sized relative to a cross-sectional dimension of the extruded component 10 such that the antimicrobial components 12 extend radially outward from an outer surface 14 of the extruded material 16 forming the extruded component 10. A color dye coating 18 may be placed on the outer surface 14 of the extruded material 16, as shown in FIGS. 1 and 2. The antibacterial component 12 may be sized such that the color dye coating 18 may be applied to the outer surface 14 of the extruded material 16 without compromising the effectiveness of the antibacterial component 12.

The extruded component 10, as shown in FIGS. 1-5, may be formed using a polymer extrusion such as a melt spun, a solvent based process, or other appropriate process. The extrusion process used to form the extruded component may not compromise the characteristics of the extruded component 10. The extruded component 10 may be formed from materials, such as, but not limited to, polymers including Nylon 6,6; Nylon 6, Polyester, Kevlar, Nomex, and other appropriate materials. The Nylon 6,6 may be extruded at temperatures of between about 280 degrees Celsius and about 300 degrees Celsius. The extruded component 10 may be formed from a single component, bicomponent, tricomponent or other such configuration. The extruded component 10 may be formed from different styles such as, but not limited to, filaments, staple, micro fibers, fabrics, a coating or other shapes, such as, but not limited to, trilobal, island in the sea, sixteen wedges, and others.

The antimicrobial component 12 may be, but is not limited to, salts, pure metals, or alloys. In one embodiment, micro or nano sized salts, pure metals or alloys may be included in the extruded component 10. The pure metals may include, but are not limited to, silver, tin, copper, zinc, cobalt, gold or other metals. The alloys may be formed from any appropriate metal in any appropriate percentage, such as, but not limited to, between about 0.1 percent and about 30 percent. The micro or nano sized antimicrobial component 12 may have sizes between 200 nm and 100 microns.

The extruded component 10 may provide a unique method for micro or nano scale crystals, or both, to deliver optimum amounts of antimicrobial component 12 such as metal ions which may be silver, copper or other metals, or any combination thereof, to kill microbes. The extruded component 10 may provide a maximum kill rate or anti-microbial efficacy within a very short time due to the enormous surface area of the crystals. The various degrees of metal thickness on the surface of particles forming the antimicrobial component 12 can create diverse ranges of surface resistivity for anti-static and shielding applications. Discrete particle distribution of the antimicrobial components 12 dispersed on the surface 14 without any contact to each other may create infinite resistance.

In one embodiment, as shown in FIG. 5, the extruded component 10 may be formed into a coating 20 capable of being applied onto other materials 26. The coating 20 can be formed from a single component, a bicomponent, or other appropriate configuration with same or different polymers. The extruded component 10 may be formed in percentages of extruded material 16 to antimicrobial component of 50%-50%, 60%-40%, 70%-30%, 80%-20%, 90%-10% or 95%-5% or any other combination.

In at least one embodiment, as shown in FIGS. 1 and 2, the extruded component 10 may be formed from a core 22 having a surrounding sheath 24. The antimicrobial components 12, such as, but not limited to, salts, pure metals, or alloys, may be included in the sheath 24. By limiting the antimicrobial components 12 to only being positioned in the sheath 24 and not in the core 22, the amount of antimicrobial components needed is greatly reduced, thereby greatly reducing the production costs without compromising the effectiveness of the antimicrobial components 12. The diameter of the extruded component 10 may be between about 1.5 micron, in which the core 22 has a diameter of about 1.2 microns and the sheath 24 has a thickness of about 0.3 microns, and about 1,000 microns, in which the core 22 has a diameter of about 800 microns and the sheath 24 has a thickness of about 200 microns. The diameter of the extruded component 10 may be formed from 80 percent core 22 and 20 percent sheath 24.

In the extruded component 10, the size of the metal ions forming the antimicrobial component 12 causes the metal ions to extend radially outward from the surface 14 of the extruded component 10. In such position, the extruded component 10 may be dyed without compromising the effectiveness of the metal particles. The size of the metal ions of the antimicrobial component 12 enables the metal particles to protrude radially outwardly from the surface 14 of the sheath 24 of the extruded component 10 a sufficient distance such that when dyed, the metal particles 12 are not completely coated with the dye, thereby not negatively impacting the efficiency of the metal particles 12.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. An extruded component, comprising:
an extruded material forming a general elongated shape; and
at least one antibacterial component in the extruded materials that extends radially outward from an outer surface of the extruded material.

2. The extruded component of claim 1, further comprising a color dye coating on the outer surface of the extruded material.

3. The extruded component of claim 2, wherein at least a portion of the at least one antibacterial component protrudes through the color dye coating.

4. The extruded component of claim 1, wherein the extruded material is formed from polymers.

5. The extruded component of claim 1, wherein the extruded material is formed from a configuration selected from the group consisting of a single component, a bicomponent and a tricomponent.

6. The extruded component of claim 1, wherein the extruded material is formed into a shape selected from the group consisting of a filament, staple, microfiber, and fabrics.

7. The extruded component of claim 1, wherein the at least one antibacterial component is formed from at least one material selected from the group consisting of salts, pure metals, and alloys.

8. The extruded component of claim 7, wherein the pure metals is selected from the group consisting of sliver, tin, copper, zinc, cobalt and gold.

9. The extruded component of claim 1, wherein the at least one antibacterial component may have a cross-sectional dimension of between 200 nm and 100 microns.

10. The extruded component of claim 1, wherein the extruded material may have a cross-sectional dimension of between about 1.5 microns and 1,000 microns.

11. An extruded component, comprising:
an extruded material forming a general elongated shape having a cross-sectional dimension of between about 1.5 microns and 1,000 microns; and
at least one antibacterial component in the extruded materials that extends radially outward from an outer surface of the extruded material;
a color dye coating on the outer surface of the extruded material
wherein the at least one antibacterial component may have a cross-sectional dimension of between 200 nm and 100 microns, thereby enabling the color dye coating to be applied to the outer surface of the extruded material without compromising the effectiveness of the at least one antibacterial component.

12. The extruded component of claim 11, wherein at least a portion of the at least one antibacterial component protrudes through the color dye coating.

13. The extruded component of claim 11, wherein the extruded material is formed from polymers.

14. The extruded component of claim 11, wherein the extruded material is formed from a configuration selected from the group consisting of a single component, a bicomponent and a tricomponent.

15. The extruded component of claim 11, wherein the extruded material is formed into a shape selected from the group consisting of a filament, staple, microfiber, and fabrics.

16. The extruded component of claim 11, wherein the at least one antibacterial component is formed from at least one material selected from the group consisting of salts, pure metals, and alloys.

17. The extruded component of claim 16, wherein the pure metals is selected from the group consisting of sliver, tin, copper, zinc, cobalt and gold.

18. An extruded component, comprising:
an extruded material formed from polymers and forming a general elongated shape having a cross-sectional dimension of between about 1.5 microns and 1,000 microns; and
at least one antibacterial component formed from silver in the extruded materials that extends radially outward from an outer surface of the extruded material;
a color dye coating on the outer surface of the extruded material
wherein the at least one antibacterial component may have a cross-sectional dimension of between 200 nm and 100 microns, thereby enabling the color dye coating to be applied to the outer surface of the extruded material without compromising the effectiveness of the at least one antibacterial component.

19. The extruded component of claim 18, wherein the extruded material is formed from a configuration selected from the group consisting of a single component, a bicomponent and a tricomponent.

20. The extruded component of claim 18, wherein the extruded material is formed into a shape selected from the group consisting of a filament, staple, microfiber, and fabrics.
